(19) United States
(12) Patent Application Publication
(10) Pub. No.: US 2011/0085467 A1
(43) Pub. Date: Apr. 14, 2011

(54) Method and Apparatus for Clustering Based Optimal Fiber Ring Deployment

(76) Inventors: Sarat Puthenpura, Berkeley Heights, NJ (US); David G. Belanger, Hillsborough, NJ (US); Arun Jotshi, Lake Hiawatha, NJ (US); Gopalakrishnan Meempat, East Brunswick, NJ (US); Sam Houston Parker, Cranbury, NJ (US); Ravi Raina, North Brunswick, NJ (US); Wenjie Zhao, Princeton, NJ (US)

(21) Appl. No.: 12/578,053

(22) Filed: Oct. 13, 2009

(51) Int. Cl. H04L 12/28

(52) U.S. Cl. 370/254

(57) ABSTRACT

A computer readable storage medium stores a set of instructions executable by a processor. The instructions are operable to receive a data set including data corresponding to a set of nodes, the data corresponding to each of the nodes including a node prize, a node cost, and a node value that is the difference between the node prize and the node cost; select one or more of the nodes for inclusion in a cluster, the cluster comprising the one or more of the nodes, two or more external links from nodes in the cluster to a network, and one or more internal links between nodes if the cluster comprises two or more nodes, each of the internal links having an internal link cost, each of the external links having an external link cost; and determine a plan for incorporating the one or more nodes in the cluster into the network, the incorporating comprising building the cluster by building the two or more external links and the one or more internal links.

### BACKGROUND

Network service providers operating large-scale networks may connect some customers to a backbone network via equipment and connections that are leased from third parties. Such a service provider may wish to reduce expenditures due to such leases by expanding a core network operated by the service provider to connect to such customers directly, obviating the need to access leased equipment and connections. Various costs may be incurred in such expansion of the core network. Thus, the selection and configuration of customer locations to add to the backbone network should be optimized.

### SUMMARY OF THE INVENTION

A computer readable storage medium stores a set of instructions executable by a processor. The instructions are operable to receive a data set including data corresponding to a set of nodes, the data corresponding to each of the nodes including a node prize, a node cost, and a node value that is the difference between the node prize and the node cost. The instructions are further operable to select one or more of the nodes for inclusion in a cluster, the cluster comprising the one or more of the nodes, two or more external links from nodes in the cluster to a network, and one or more internal links between nodes if the cluster comprises two or more nodes, each of the internal links having an internal link cost, each of the external links having an external link cost. The instructions are further operable to determine a plan for incorporating the one or more nodes in the cluster into the network, the incorporating comprising building the cluster by building the two or more external links and the one or more internal links.

A system includes a memory and a processor. The processor is configured to receive a data set including data corresponding to a set of nodes, the data corresponding to each of the nodes each of the nodes including a node prize, a node cost, and a node value that is the difference between the node prize and the node cost and select one or more of the nodes for inclusion in a cluster, the cluster comprising the one or more of the nodes, two or more external links from nodes in the cluster to a network, and one or more internal links between nodes if the cluster comprises two or more nodes, each of the internal links having an internal link cost, each of the external links having an external link cost and determine a plan for incorporating the one or more nodes in the cluster into the network, the incorporating comprising building the cluster by building the two or more external links and the one or more internal links.

A system includes means for receiving a data set including data corresponding to a set of nodes, the data corresponding to each of the nodes including a node prize, a node cost, and a node value that is the difference between the node prize and the node cost. The system further includes means for selecting one or more of the nodes for inclusion in a cluster, the cluster comprising the one or more of the nodes, two or more external links from nodes in the cluster to a network, and one or more internal links between nodes if the cluster comprises two or more nodes, each of the internal links having an internal link cost, each of the external links having an external link cost. The system further includes means for incorporating the one or more nodes in the cluster into the network, the incorporating comprising building the cluster by building the two or more external links and the one or more internal links.

### BRIEF DESCRIPTION OF THE DRAWINGS

FIG. 1 shows an exemplary method for clustering nodes for incorporation into a communications network according to an exemplary embodiment.

FIG. 2 shows sub-steps of a step of the exemplary method of FIG. 1.

FIG. 3 shows sub-steps of a step of the exemplary method of FIG. 1.

FIG. 4A shows a cluster of nodes prior to the execution of the sub-steps shown in FIG. 3.

FIG. 4B shows a cluster of nodes after the execution of the sub-steps shown in FIG. 3.

FIG. 5 shows sub-steps of a step of the exemplary method of FIG. 1.

FIG. 6 shows a system according to an exemplary embodiment.

### DETAILED DESCRIPTION

The exemplary embodiments may be further understood with reference to the following description and the appended drawings, wherein like elements are referred to with the same reference numerals. The exemplary embodiments describe methods and systems for selecting and grouping nodes for incorporation into a communications network.

Network service providers, such as telecommunications providers, may typically coordinate their communications through a main core or backbone network. Customers who are not directly connected to the provider's backbone network may be connected via equipment and/or communications links that are leased from third parties. The expenditure incurred in such leases may be significant; therefore, a service provider may wish to expand its backbone network to such customers directly, rather than via such leased equipment, in order to reduce or eliminate such costs. Various costs may be incurred in order to do so; such costs may include construction of new communications links and installation of equipment within customer facilities.

Thus, to maximize return on investment, a service provider may wish to optimize the selection of customers to add to its backbone network. Further, once a group of customer locations (also referred to herein as “nodes”) has been selected for connection to the backbone network, the service provider may wish to group the selected locations into one or more “clusters” to be interconnected with one another and share common connections to the backbone network itself. Such clusters may typically be bi-connected, meaning that a cluster is connected to the backbone in two separate locations and that the locations within the cluster are interconnected in such a manner as to insure that no failure of a single connection may result in inability to communicate with any of the locations.

Communications networks may include hundreds or thousands of customer locations under consideration for incorporation into the backbone. Thus, it is desirable to select and cluster locations efficiently in order to make such determinations optimally and in a reasonable amount of time. Previous efforts for the selection process have mainly involved ad hoc methods for selecting and clustering locations on a manual basis, resulting in sub-optimal clustering or failure to select some candidates for clustering. The exemplary embodiments present methods and systems for optimal selection and clustering of locations. While the exemplary embodiments are described with reference to an optimal clustering of telecommunications nodes, the present invention is applicable to any clustering operation.

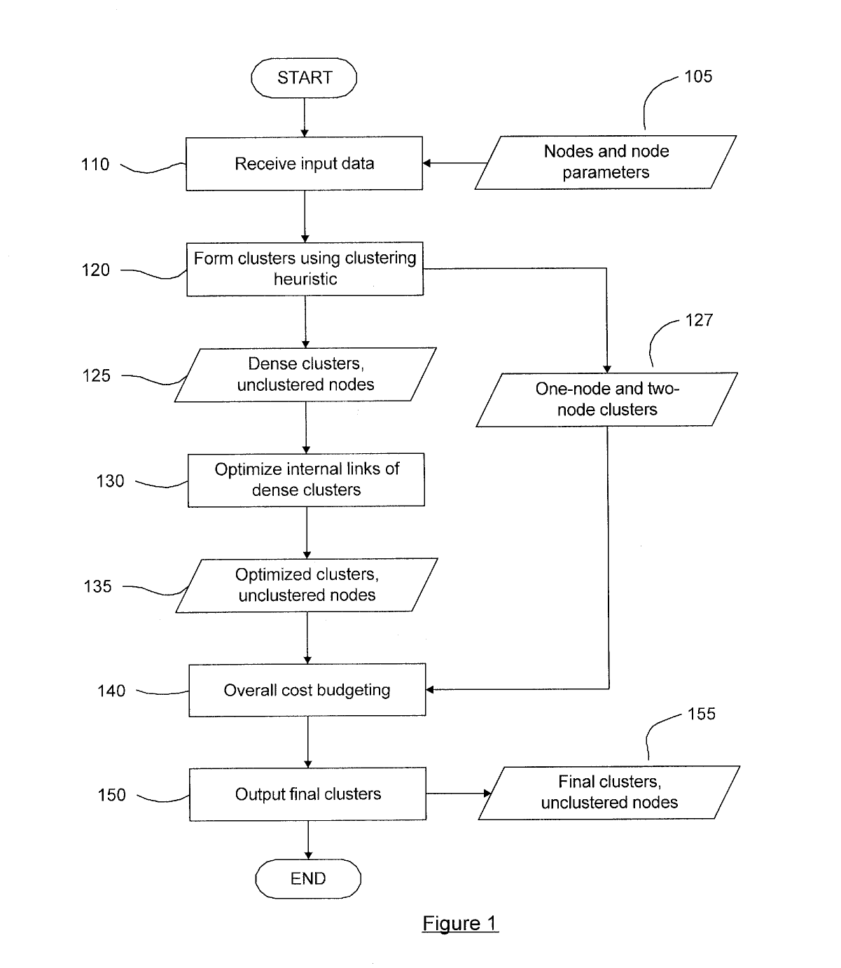

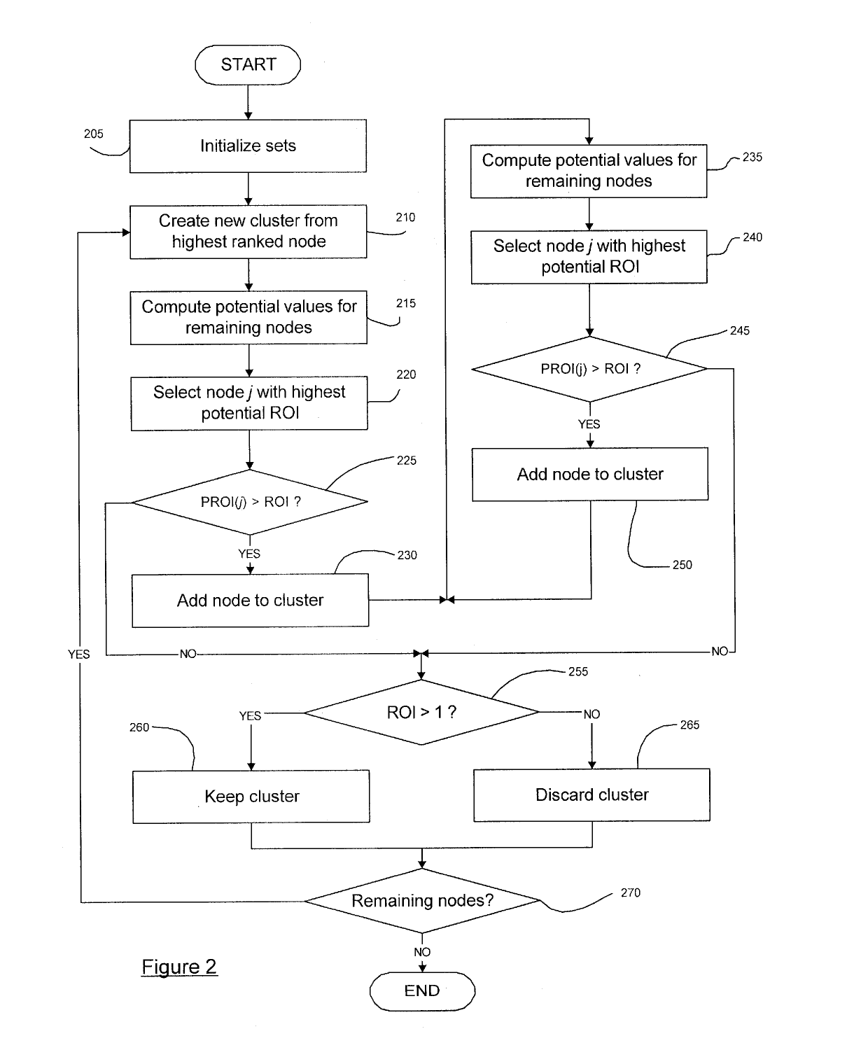

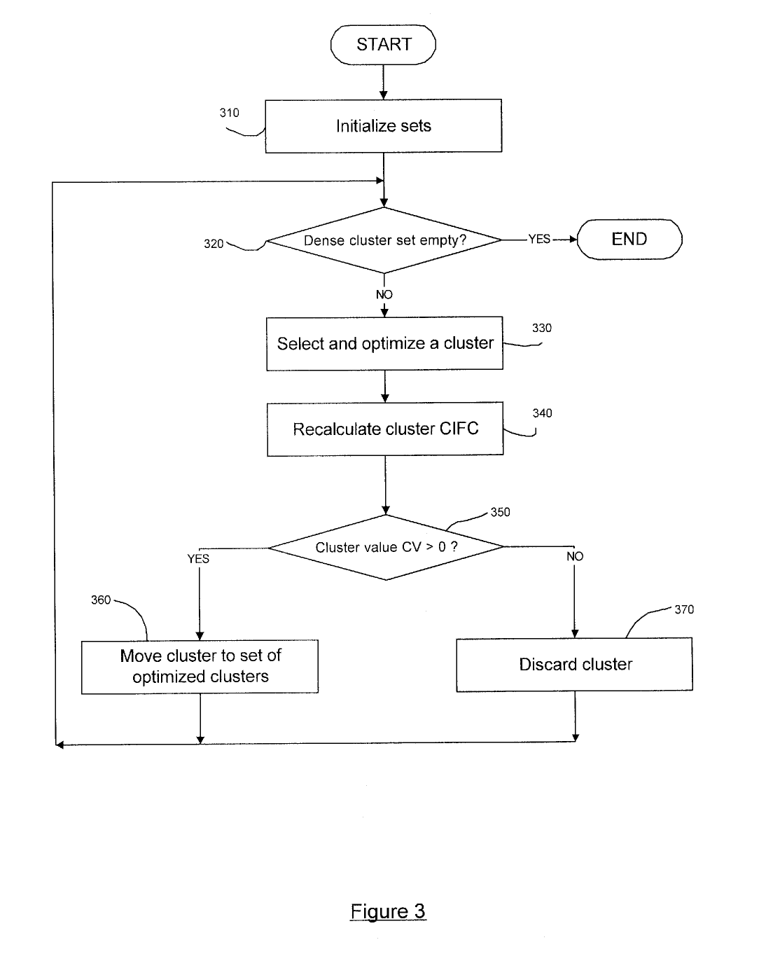

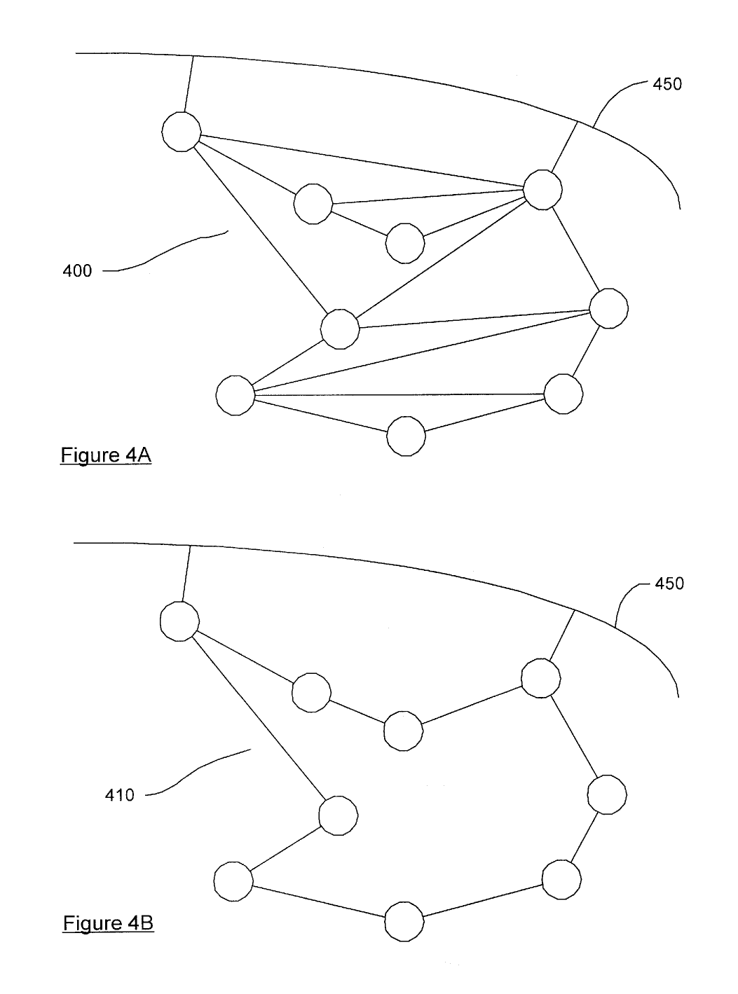

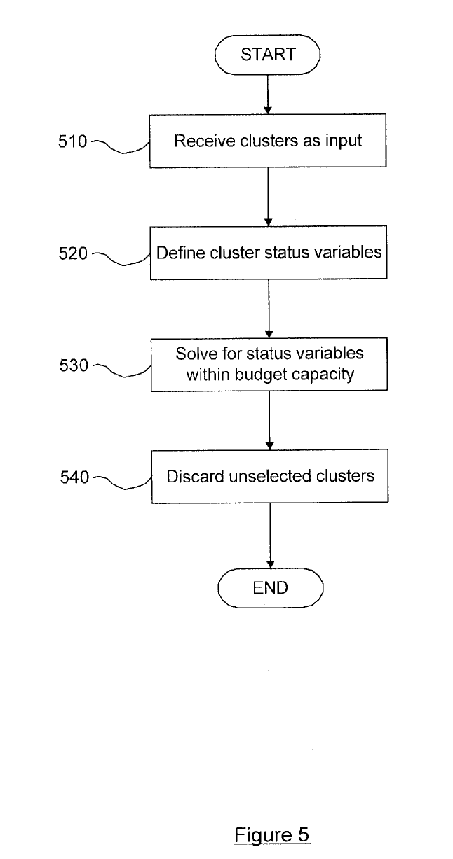

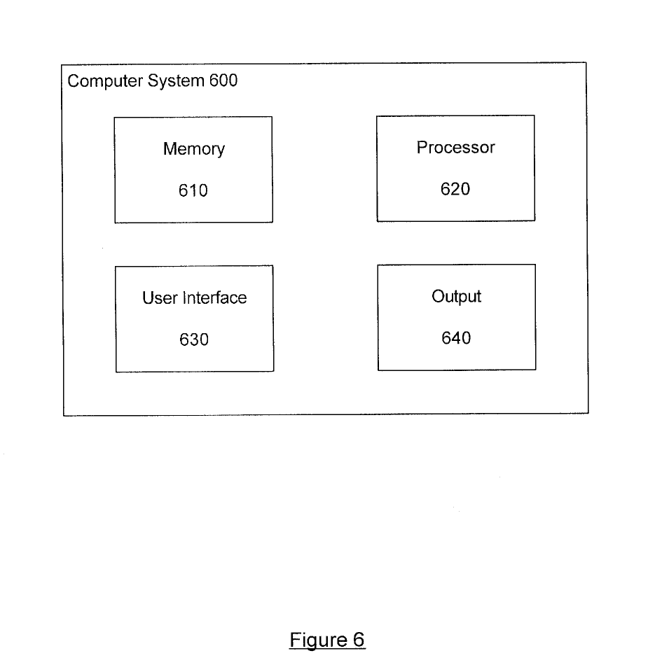

FIG. 1 illustrates a method 100 according to an exemplary embodiment. FIG. 2, FIG. 3 and FIG. 5 each illustrate a single step of the method of FIG. 1, broken into sub-steps as will be described below. FIGS. 4a and 4b provide more detail on the operation of the method of FIG. 3. Those of skill in the art will understand that the exemplary method may be, for example, performed by computer-executable code operable by a processor and stored in a computer memory or computer-readable storage medium according to principles that are known in the art. FIG. 6 illustrates a schematic view of a computer system 600, including a processor 620, that may perform the exemplary method 100.

In a first step 110 of the method 100, input data 105 is initialized. This input data 105 may be received from a database, entered manually, etc. The input data may include a set of nodes, each node i of which is characterized by a set of values. A prize value P(i) represents the financial gain (e.g., cost savings due to not needing to lease equipment to connect to the node i) by including the node in the backbone network. A building cost BC(i) represents a fixed cost (e.g., cost to install network equipment in a building, etc.) to include the node i in the backbone network. A pair of connection points (or “hooks”) h1(i) and h2(i) represent the closest two locations to at which the node i may be connected directly to the backbone network. A pair of costs K1(i) and K2(i) represent the cost to connect the node i to the locations h1(i) and h2(i), respectively. The external links that may be formed from the node i to the hooks h1(i) and h2(i) are termed E1(i) and E2(i), respectively. From these values, a singleton value SV is determined as SV(i)=P(i)−BC(i)−K1(i)−K2(i). SV(i) represents the value of connecting the node i to the backbone network without clustering it with other nodes (e.g., as a single-node cluster.)

In step 120, the processor 620 groups the nodes into clusters. Step 120 comprises a plurality of sub-steps, shown in more detail in the method of FIG. 2. In step 205, the processor 620 initializes the data for the clustering process. A set of unclustered nodes, a set of pruned nodes, and a set of clusters are created. The processor 620 places all input nodes from step 110 into the set of unclustered nodes and ranks them; ranking may be, for example, by singleton value SV or by prize value P. The sets of pruned nodes and clusters are initially empty.

In step 210, the processor 620 moves the highest-ranked node t in the set of unclustered nodes to a new cluster and defines it as the “cluster leader”. A cluster prize value CP is defined as P(t); cluster seed locations s1 and s2 are set as equal to t. A total cluster building cost CBC is equal to the building cost BC(t). The external links for the new cluster, CE1 and CE2, are set as E1(t) and E2(t) respectively, and the cluster external fiber cost CEFC is set as equal to K1(t)+K2(t). The cluster internal fiber cost CIFC, representing the cost to connect the nodes within the cluster to one another, is initially set at zero, as there is no cost to connect the node t to itself. Last, a cluster return on investment ROI is set as equal to CP/(CBC+CEFC+CIFC).

In step 215, for each remaining node i in both the set of unclustered nodes and the set of pruned nodes, the processor 620 calculates a set of potential figures based on the hypothetical inclusion of each node (and only each single node) into the cluster created in step 210. A potential cluster prize PCP(i) is equal to CP+P(i). A potential cluster building costs PCBC(i) is equal to CBC+BC(i). A potential cluster internal fiber cost PCIFC(i) is equal to LC(s1,i), which is the cost to construct a link from the cluster seed s1 to the node under consideration i. A potential cluster external fiber cost PCEFC(i) is equal to K1(s1)+K1(i). Finally, a potential return on investment PROI(i)=PCP(i)/(PCBC(i)+PCIFC(i)+PCIFC(i)). As stated above, a value for PROI(i) is calculated for each node i in both the sets of unclustered nodes and of pruned nodes.

In step 220, the processor 620 selects a node j such that PROI(j) is the maximum value of all the values PROI(i) calculated in step 215. In step 225, the processor 620 compares the maximum potential return on investment PROI(j) to the existing ROI for the cluster. If the existing ROI is greater than the potential return on investment PROI(j), then the node j is not added to the cluster and the method continues in step 255, to be discussed below. If the potential return investment PROI(j) is greater than the existing ROI, then the method continues in step 230.

In step 230, the processor 620 moves the node j to the cluster created in step 210, and updates the cluster values accordingly. The cluster prize CP is set as equal to PCP(j), the cluster building costs CBC is set as equal to PCBC(j), the cluster internal fiber cost CIFC is set as equal to PCIFC(j), and the cluster external fiber cost CEFC is set as equal to PCEFC(j). The processor 620 adds an internal link (j,s1) to the cluster. The first seed location s1 is updated to be the location k in the set of locations (s1,j) such that E(k) is minimized, and the second seed location s2 is updated to be the location m in the set of locations (s1,j) such that E(m) is maximized. If necessary, the external link costs CE1 and CE2 are updated such that CE1=E1(s1) and CE2=E1(s2).

In step 235, the processor re-evaluates all remaining nodes i in the set of unclustered nodes and the set of pruned nodes; this evaluation is different from that of step 215, because the evaluation of step 215 is specific to a cluster that only contains one node. For each node i being evaluated, the processor 620 selects two closest nodes to i that are already in the cluster, i.n1 and i.n2. As in step 215, the potential cluster prize PCP(i)=CP+P(i), and the potential cluster building cost PCBC(i)=CBC+BC(i).

Also in step 235, the processor 620 determines a potential cluster internal fiber charge for each node i as PCIFC(i)=CIFC+(α/2)(LC(i,i.n1)+LC(i,i.n2)). Here, α is a tuning parameter that optimistically scales the cluster internal link cost, in anticipation of the removal of some links within a cluster as will be discussed in further detail below. The tuning parameter α is present in order to insure that cluster growth does not terminate prematurely. α is a predetermined value that is typically between 1 and 2; a value of α greater than 2 would have the opposite effect from that described above.

Further in step 235, the processor 620 determines the potential cluster external fiber charge for each node i as K1(s1)+K2(s2)+K1(i)−Max(K1(s1), K2(s2), K1(i)). Thus, if using the node i's external link to its closest location on the existing fiber E1(i), having cost K1(i), would reduce the external linking cost of the cluster, then it replaces the more expensive of the two external links currently being used for the cluster. Conversely, if the two external links already being used for the cluster are both less expensive than the less expensive of the node i's links, then they are retained. Finally, as above, a potential return on investment PROI for each of the nodes is calculated as PROI(i)=PCP(i)/(PCBC(i)+PCIFC(i)+PCEFC(i)).

In step 240, as in step 220, the processor 620 selects a node j such that PROI(j) is the maximum value of all the values PROI(i) calculated in step 235. In step 245, the processor 620 compares the maximum potential return on investment PROI(j) to the existing ROI for the cluster. If the existing ROI is greater than the potential return on investment PROI(j), then the node j is not added to the cluster and the method continues in step 255, to be discussed below. If the potential return investment PROI(j) is greater than the existing ROI, then the method continues in step 250.

In step 250, as in step 230, the processor 620 adds the selected node j to the cluster. The cluster prize CP is set as equal to PCP(j), the cluster building costs CBC is set as equal to PCBC(j), the cluster internal fiber cost CIFC is set as equal to PCIFC(j), and the cluster external fiber cost CEFC is set as equal to PCEFC(j). Internal links (j,j.n1) and (j,j.n2) are added to the cluster. The first seed location s1 is updated to be the location k in the set of locations {s1,s2,j) such that E(k) is minimized, and the second seed location s2 is updated to be the location m in the set of locations {s1,s2,j} such that E(m) is the second lowest of the set. If necessary, the external link costs CE1 and CE2 are updated such that CE1=E1(s1) and CE2=E1(s2). After step 250, the method returns to step 235 and further nodes are considered for addition to the cluster.

If, in step 225 or step 245, it has been determined that the most promising node j under consideration does not improve the overall ROI of the cluster, then the method will have proceeded to step 255. In this step, the processor 620 evaluates the current cluster (formed in steps 210 through 230 and one or more iterations in steps 235 through 250). If the ROI of the cluster is greater than 1 (i.e., if the cluster prize CP exceeds its total costs), then the method proceeds to step 260. In this step, the processor 620 adds the cluster to the set of clusters that was created in step 205, and the method continues in step 270.

Conversely, if the ROI of the cluster is not greater than 1 (i.e., if the total costs of the cluster are greater than or equal to its cluster prize CP), then the method proceeds to step 265. In this step, the processor 620 moves all nodes in the cluster to the set of pruned nodes created in step 205, and the cluster is discarded. After this, the method continues in step 270.

In step 270, the processor 620 considers set of unclustered nodes. If nodes remain in this set, the method returns to step 210, and the processor 620 repeats the process of cluster formation as described above. Nodes in the set of pruned nodes, which had been included in an aborted cluster but subsequently removed, are not considered in this step. If step 270 is reached and no nodes remain in the set of unclustered nodes, the method (i.e., step 120 of the method 100) terminates.

At the conclusion of this step, data remaining will include the set of clusters and the set of pruned nodes 125. The set of clusters is subdivided at this point. Clusters containing three or more nodes (termed “dense clusters”), together with the set of pruned nodes, are used in the performance of step 130. Clusters containing one or two nodes 127 are separated out and used subsequently in step 140, to be described below.

Step 130 presents the process of the optimization of internal links within clusters. It will be apparent to those of skill in the art that because a cluster having one node has no internal links, and a cluster having two nodes has only one internal link that cannot be removed, this process is not applicable to such clusters, resulting in their omission from use in this step as described above. Step 130, like step 120, comprises a plurality of sub-steps, and will therefore be shown in more detail in the method of FIG. 3.

In step 310, the processor 620 initializes two sets, a dense cluster set DC and an optimized cluster set OC. The set DC contains the clusters created in step 120 of method 100, with the exception of clusters containing one or two nodes as described above, while the set OC is initially empty. In step 320, the processor 620 evaluates the set DC to determine whether it is empty. This step is performed at the beginning of the method to allow for the possibility that no dense clusters were created in step 120. If no dense clusters exist in the set DC, the method terminates. If the set DC is not empty, the method continues to step 330.

In step 330, the processor 620 selects a cluster from the set DC and performs link optimization on that cluster. Each cluster is considered separately, as will be described below; thus, the order in which the clusters are considered is irrelevant. In one example, they may be selected based on the order in which they were created in step 120, but other orders may be possible. Link optimization is performed by defining an expression to represent the total cost of the set of internal links that are maintained, defining a set of conditions that the set of maintained internal links must satisfy, and solving for the set of internal links that minimizes the cost while satisfying all the conditions. Solution may be accomplished, for example, by using the A Mathematical Programming Language (“AMPL”) language to formulate the problem as a linear problem (“LP”), and using an external solver such as CPLEX to solve the LP. However, those of skill in the art will understand that other solution methods may be possible.

The cluster under consideration will include a set of nodes N, a subset R of N comprised of the two root nodes (e.g., the seed nodes discussed above), a set of links L comprised of all internal links created in the formation of the cluster in step 120, and a set of link costs C_{(j,k)} for each link (j,k) in the set L. A set of binary link status variables {z} is also defined for the collection of links in the set L; z_{(j,k)} will evaluate to zero for a link (j,k) that is eliminated by the optimization process, or will evaluate to one if the link is maintained during this process. Also used in the set of conditions to be solved is a variable xᵢᵣⱼₖ, which is a binary variable denoting the component of an aggregate directed “flow” along a connected path from non-root node i (which may be any node in the set N excluding the two root nodes that are also in the set R) to root node r (which may be one of the two nodes in the set R), transiting from node j to node k (both of which may be any pair of non-identical nodes in the set N), on the link (j,k) between those two nodes, provided that such a link is defined in the input set L. As those who are skilled in the art may appreciate, the binary restriction on these variables, in conjunction with the conditions stated below, ensures that a unique simple connected path is selected without any branches or bifurcations.

The processor 620 defines a set of conditions to insure that there is a link-disjoint path from each non-root node to each of the two root nodes (e.g., there should be a unique non-branching path from each non-root node to the first root node, and a second unique non-branching path from each non-root node to the second root node, and the two paths should not share any common link), in order to insure bi-connectivity for each node in the cluster. The conditions may be expressed as follows:

1. xᵢᵣⱼₖ ε {0,1}, i ε N−R, r ε R; j ε N, k ε N; (j, k) ε L

This condition enforces the binary constraint.

2. xᵢᵣⱼₖ=0, i ε N−R, r ε R; j ε R; k ε N; (j, k) ε L

This condition ensures that no flow that has reached one of the root nodes will proceed any further.

$$3. {\sum }_{r ε R}^{ } ( {x}_{irjk} + {x}_{irkj} ) \leq {z}_{( j , k )} , i ε N - R ; j ε N , k ε N ; ( j , k ) ε L$$

This condition ensures that a link is activated if there is a flow transiting the link in either direction; in conjunction with constraint 7 below, it is also ensured that at most one of the two flows originating at each source node can transit any given link. It should be understood that if the flow from at least one non-root i to one of the two root nodes transits the link (j,k) in either direction, then z_{(j,k)} is equal to one and the link (j,k) is maintained; otherwise, it is not. It can also be seen that this condition, in combination with constraint 8 below, ensures that a link (j,k) will not be shared by the path from the non-root node i to the first root node and the path from the same non-root node i to the second root node.

$$4. {\sum }_{k ε N , ( i , k ) ε L}^{ } {x}_{irik} = 1 , i ε N - R , r ε R$$

This constraint ensures that exactly one flow originates from each non-root node to each of the two root nodes.

$$5. {\sum }_{j ε N - R , ( j , r ) ε L}^{ } {x}_{irjr} = 1 , i ε N - R , r ε R$$

This constraint ensures that each of the two root nodes is the terminus of exactly one flow from each of the non-root nodes.

$$6. {\sum }_{w ε N - R , ( w , j ) ε L}^{ } {x}_{irwj} = {\sum }_{k ε N , ( j , k ) ε L}^{ } {x}_{irjk} , i ε N - R ; r ε R ; j ε N - R ; j \neq i$$

This constraint ensures that the total incoming volume of every flow at each intermediate node equals its total outgoing volume.

As described above, the optimal set of values for {z} that yield a set of links satisfying bi-connectivity at the lowest internal link cost can be determined by solving a mixed integer programming (MIP) problem with the set of constraints listed above, in conjunction with the additional constraint and optimization criterion specified below.

7. z_{(j,k)} ε [0,1], (j, k) ε L

This condition enforces the binary constraint; also, the upper bound of 1, in conjunction with constraint 3 above, ensures that at most one of the two flows originating at each source node can transit any given link.

8. Minimize total link cost

$$C = {\sum }_{( j , k ) ε L}^{ } {C}_{( j , k )} {z}_{( j , k )}$$

This minimization optimizes the set of links to be chosen.

Using the solvers described above (e.g., AMPL language with CPLEX solver), the processor 620 may accomplish execution in a reasonable amount of time; for example, a cluster including 500 nodes may be solved in less than a minute. Further, it may easily be verified that a mathematical relaxation of the above mixed integer programming method, where the 0-1 constraint on the z variables is replaced by a linear constraint of the form 0≦z≦1, yields identical results. Exploitation of this property can lead to some degree of acceleration of the execution. Additionally, experience demonstrates that a further relaxation, where the binary constraint on the set of xᵢᵣⱼₖ variables is also replaced by a linear 0≦xᵢᵣⱼₖ≦1 constraint, yields a pure LP method that typically produces identical results. While it has not been proven rigorously, it is suspected that the LP polytope corresponding to the aforementioned constraint set (1-7) has integer-valued corner points. This attribute has the potential to further speed up the execution.

FIGS. 4A and 4B illustrate two stages in the formation of a dense cluster of nodes. FIG. 4A illustrates a dense cluster 400 attached to a backbone network 450 and including nine nodes and fifteen internal links as may be created by the performance of step 120 as illustrated in FIG. 2. FIG. 4B illustrates an optimized cluster 410, which may be the resulting modification of the dense cluster 400 after the application of the performance of step 130 as illustrated in FIG. 3. The optimized cluster maintains bi-connectivity while reducing the number of internal links to nine.

After internal link optimization has been performed on a cluster, in step 340 the processor 620 recalculates the cluster internal fiber cost by adding the costs of the remaining links. The a scaling used above is not used here. The processor 620 determines a new cluster value by subtracting all the costs of the cluster from the new cluster prize; this may be expressed as CV=CP−CBC−CIFC−CEFC, where only CIFC has been modified in preceding step 330. In step 350, the processor 620 evaluates the acceptability of the cluster value CV. If CV is greater than zero, then in step 360 the processor 620 places the cluster in the optimized cluster set OC. If CV is not greater than zero, then in step 370 the processor 620 deletes the cluster and all nodes in the cluster are moved to the set of pruned nodes (which was part of the data set 125 provided by step 120). After step 360 or step 370, the method returns to step 320, where the method is repeated for the next cluster or the method ends because all clusters have been processed. At the end of this process, the data 135 now includes optimized clusters and pruned nodes.

Returning to the method 100 of FIG. 1, the processor 620 returns the clusters with fewer than three nodes 127, removed prior to step 130, to the data set and merges these clusters with the link optimized set of clusters provided by step 130 in the data set 135 to be used for step 140. The set of pruned nodes furnished in the data set 135 is also carried through the final processing step 140. This step presents a budgeting process by which the set of clusters remaining may be further pruned in order that their total cost may be maintained below a fixed budget. As above, step 140 comprises a plurality of sub-steps, and will therefore be shown in more detail in the method of FIG. 5.

In step 510, the processor 620 receives all clusters c as inputs to the set of clusters C. This includes both the optimized clusters from the set OC discussed above with reference to the method of FIG. 3, as well as the one-node and two-node clusters separated out prior to step 130. Also received as an input in step 510 is a total budget CPX, which represents the maximum allowable expenditure for all clusters to be created. In step 520, a binary cluster status variable Y_{c} is defined for each cluster; this variable is similar to the link status variable z discussed above with reference to the method of FIG. 3, and may be one or zero to indicate whether the corresponding cluster is maintained or removed. Each cluster also has a cluster value CV as defined above, and a cluster cost K which is equal to the sum of its cluster building costs CBC, its cluster internal fiber cost CIFC, and its cluster external fiber cost CEFC.

In step 530, the processor 620 initiates a set of rules, similar to that discussed above with reference to the method of FIG. 3. The first rule,

$${\sum }_{C ε C}^{ } {K}_{c} {Z}_{c} \leq CPX ,$$

insures that for all clusters that are maintained (i.e., clusters with Y value 1), the total cost (K for each cluster) is less than the value CPX. The second rule is that the value

$${\sum }_{C ε C}^{ } {CV}_{c} {Z}_{c}$$

is maximized. This insures that the aggregate value of the clusters that are retained is maximized, and that the maximum overall value possible within the budget CPX is attained by the system. These rules may be solved by methods that are known in the art, such as using the AMPL language with the CPLEX solver as discussed above.

In step 540, the processor 620 discards each cluster with a Y value of zero and moves constituent nodes of such clusters to the set of pruned nodes. Returning to the method 100 of FIG. 1, in step 150 the processor 620 outputs remaining clusters 155 as the final result of the exemplary method 100.

FIG. 6 illustrates a schematic view of a computer system 600 that may perform the exemplary method 100, as described above. The system 600 may include a memory 610 that may store a program embodying the method 100. The memory 610 may be, for example, a hard drive, a CD-ROM storage, etc. The system 600 may further include a processor 620, a user interface 630, and an output 640. The processor 620 may be any of the various processors known in the art and suitable for performing the exemplary method 100. The user interface 630 may include a keyboard, a mouse, a touch-sensitive display, or any other mechanism by which a user may provide input. The output 640 may include a monitor, a printer, or any other mechanism by which results of the method 100 may be provided to a user.

The exemplary embodiments may provide improved results as compared to prior art methods. Return on investment and overall value provided may be maximized, while costs may be limited to a fixed budget and time of execution may be minimized.

It will be apparent to those skilled in the art that various modifications may be made in the present invention, without departing from the spirit or the scope of the invention. Thus, it is intended that the present invention covers modifications and variations of this invention provided they come within the scope of the appended claims and their equivalents.

What is claimed is:

1. A computer readable storage medium storing a set of instructions executable by a processor, the instructions being operable to:
receive a data set including data corresponding to a set of nodes, the data corresponding to each of the nodes including a node prize, a node cost, and a node value that is the difference between the node prize and the node cost;
select one or more of the nodes for inclusion in a cluster, the cluster comprising the one or more of the nodes, two or more external links from nodes in the cluster to a network, and one or more internal links between nodes if the cluster comprises two or more nodes, each of the internal links having an internal link cost, each of the external links having an external link cost; and
determine a plan for incorporating the one or more nodes in the cluster into the network, the incorporating comprising building the cluster by building the two or more external links and the one or more internal links.

2. The computer readable storage medium of claim 1, wherein the instructions are further operable to:
optimize the internal links between the nodes of the cluster, the optimizing comprising removing internal links until a minimal subset of the internal links remains.

3. The computer readable storage medium of claim 2, wherein the minimal subset comprises a subset of the internal links that has a minimum sum of the internal link costs of the internal links in the subset and that provides bi-connectivity for each of the nodes in the cluster.

4. The computer readable storage medium of claim 1, wherein the instruction operable to select the one or more of the nodes for inclusion in the cluster comprises sub-instructions to:
select a first one of the nodes;
include the first one of the nodes in the cluster;
select a further one of the nodes; and
include the further one of the nodes in the cluster, if a potential return on investment with the further one of the nodes included in the cluster is greater than a return on investment without the further one of the nodes in the cluster.

5. The computer readable storage medium of claim 4, wherein the first one of the nodes is selected to be a one of the nodes that has one of a highest node prize and a highest node value.

6. The computer readable storage medium of claim 4, wherein the further one of the nodes is selected to be a one of the nodes that has a highest potential return on investment.

7. The computer readable storage medium of claim 4, wherein the steps of selecting a further one of the nodes and including the further one of the nodes are repeated for each of the nodes that increases a potential return on investment of the cluster.

8. The computer readable storage medium of claim 1, wherein the network is one of a telecommunications network and a data network.

9. A system, comprising:
a memory; and
a processor configured to receive a data set including data corresponding to a set of nodes, the data corresponding to each of the nodes each of the nodes including a node prize, a node cost, and a node value that is the difference between the node prize and the node cost and select one or more of the nodes for inclusion in a cluster, the cluster comprising the one or more of the nodes, two or more external links from nodes in the cluster to a network, and one or more internal links between nodes if the cluster comprises two or more nodes, each of the internal links having an internal link cost, each of the external links having an external link cost and determine a plan for incorporating the one or more nodes in the cluster into the network, the incorporating comprising building the cluster by building the two or more external links and the one or more internal links.

10. The system of claim 9, wherein the processor is further configured to optimize the internal links between the nodes of the cluster, the optimizing comprising removing internal links until a minimal subset of the internal links remains.

11. The system of claim 10, wherein the minimal subset comprises a subset of the internal links that has a minimum sum of the internal link costs of the internal links in the subset and that provides bi-connectivity for each of the nodes in the cluster.

12. The system of claim 9, wherein the processor in selecting the one or more of the nodes for inclusion in the cluster is configured to select a first one of the nodes, include the first one of the nodes in the cluster, select a further one of the nodes and include the further one of the nodes in the cluster, if a potential return on investment with the further one of the nodes included in the cluster is greater than a return on investment without the further one of the nodes in the cluster.

13. The system of claim 12, wherein the first one of the nodes is selected to be a one of the nodes that has one of a highest node prize and a highest node value.

14. The system of claim 12, wherein the further one of the nodes is selected to be a one of the nodes that has a highest potential return on investment.

15. The system of claim 12, wherein the processor is further configured to repeat the selecting a further one of the nodes and including the further one of the nodes for each of the nodes that increases a potential return on investment of the cluster.

16. The system of claim 9, wherein the network is one of a telecommunications network and a data network.

17. A system, comprising:
means for receiving a data set including data corresponding to a set of nodes, the data corresponding to each of the nodes including a node prize, a node cost, and a node value that is the difference between the node prize and the node Cost;
means for selecting one or more of the nodes for inclusion in a cluster, the cluster comprising the one or more of the nodes, two or more external links from nodes in the cluster to a network, and one or more internal links between nodes if the cluster comprises two or more nodes, each of the internal links having an internal link cost, each of the external links having an external link cost; and
means for incorporating the one or more nodes in the cluster into the network, the incorporating comprising building the cluster by building the two or more external links and the one or more internal links.
